(19) United States
(12) Patent Application Publication
(10) Pub. No.: US 2006/0013672 A1
(43) Pub. Date: Jan. 19, 2006

(54) Flex lock nut having an annular recess

(76) Inventor: Jack R. Kerr, Desoto, TX (US)

Correspondence Address: MICHAEL L. DIAZ, P.C., 555 REPUBLIC DRIVE, SUITE 200, PIANO, TX, 75074, US

(21) Appl. No.: 10/889,680

(22) Filed: Jul. 13, 2004

(51) Int. Cl. F16B 39/22

(52) U.S. Cl. 411/280

(57) ABSTRACT

The present invention is a flex lock nut. The flex lock nut includes a hexagonally shaped nut body having a threaded bore. In addition, the nut body includes a collar portion formed by six slotted segments mounted on an upper end of the nut body. The collar portion has a smaller diameter than the nut body. On a bottom opposite end of the nut body is an annular recess located on a perimeter around the bore. When the flex lock nut is seated upon a thread bolt, the lock nut provides two locking features. First, while threading the nut upon the bolt, the slotted segments expand to provide a conventional upper locking feature. In addition, as the flex lock nut is continually seated upon the bolt, the annular recess deforms, thereby provide a novel second locking feature.

### BACKGROUND OF THE INVENTION

1. Field of the Invention

This invention relates to lock nuts. Specifically, the present invention relates to flex lock nut having an annular recess.

2. Description of the Related Art

The use of fastening nuts upon threaded bolts is common in many industries. Since nuts are subjected to extreme vibrations, dynamic loads, shock and stresses, the nuts are susceptible to loosening. Locking nuts are commonly used to lock a nut in place upon the threaded bolt. When lock nuts are twisted far enough onto a bolt, the lock nuts are locked into place. A common existing locking nut utilized is a “flex lock” nut. FIG. 1 is a partial cut-away view in elevation of an existing flex lock nut 10 positioned on a threaded bolt 12. The flex lock nut 10 includes a collar section 14 having a plurality of slotted segments 16. As the nut is twisted on the bolt, the slotted segments expand outwardly, thereby locking the nut in place. FIG. 2 illustrates a top plan view of the flex lock nut 10 prior to seating the nut on a bolt (not shown). FIG. 3 is a top plan view of the flex lock nut 10 in a fully locked position. As the threaded bolt enters the “locking area,” the slotted segments expand and the nut locks.

Although there are no known prior art teachings of an apparatus as that disclosed herein, prior art references that discuss subject matter that bears some relation to matters discussed herein are U.S. Pat. No. 2,299,085 to Gade (Gade) and U.S. Pat. No. 3,342,233 to Meisel.

Gade discloses a self-locking nut having a plurality of segments. When the nut is threaded onto its companion bolt, the segments bear resiliently upon the bolt and create additional friction to lock the nut in place. Meisel also discloses a self-locking nut having a plurality of segments, which are used to lock the nut in position upon the bolt.

However, none of the prior art references, including the existing flex lock nut, teaches or suggests a segmented collar portion having an annular recess located on a bottom portion of the nut. A flex lock nut is needed which includes an annular recess to provide an additional locking feature.

Thus, it would be a distinct advantage to have a flex lock nut, which incorporates both a segmented collar portion and an annular recess to provide two locking features. It is an object of the present invention to provide such an apparatus.

### SUMMARY OF THE INVENTION

In one aspect, the present invention is a lock nut having a nut body with a threaded bore running from an upper end to a lower end of the nut body. Several slotted segments extend from a collar portion on the upper end of the nut body. The slotted segments are substantially coaxial with the bore. An annular recess is positioned upon a bottom end of the nut body. The annular recess is coaxial with the threaded portion of the bore. The slotted segments expand when the nut body is seated upon a threaded bolt to provide an upper locking friction to prevent rotation of the nut body. The annular recess also deforms when the nut body is seated upon the threaded bolt to provide a lower locking friction to prevent rotation of the nut body.

In another aspect, the present invention is a lock nut having a nut body. The nut body includes a threaded bore running from an upper end to a lower end of the nut body. The nut body includes six planar exterior surfaces to provide a hexagonal shape to the nut body. A collar portion is located on the upper end of the nut body. The collar portion has a diameter smaller than the nut body. In addition, six slotted segments extend from the collar portion. Each segment is aligned with one of the planar exterior surfaces. The slotted segments form a threaded interior and are coaxially aligned with the bore. An annular recess is positioned upon the bottom end of the nut body. The annular recess is circumferentially positioned on an outer perimeter of the bore at the bottom end of the nut body. The slotted segments expand when the nut body is positioned upon a threaded bolt to provide an upper locking friction to prevent rotation of the nut body. The annular recess also deforms when the nut body is seated upon the threaded bolt to provide a lower locking friction to prevent rotation of the nut body.

In still another aspect, the present invention is a lock nut having a six-sided nut body with a threaded bore running from an upper portion to a lower portion of the nut body. Six slotted segments extend from the upper portion of the nut body and form a collar portion. The collar portion has a smaller diameter than the nut body. An annular recess is positioned on a perimeter about the bore at the lower portion of the nut body. The slotted segments expand to provide an upper locking frictional force upon a bolt being threaded within the bore. In addition, the annular recess deforms to provide a lower locking force upon the bolt as the nut body is seated upon the bolt, thereby preventing inadvertent rotation of the lock nut.

### BRIEF DESCRIPTION OF THE DRAWINGS

FIG. 1 (Prior Art) illustrates a view in elevation of a flex lock nut;

FIG. 2 (Prior Art) illustrates a top plan view of the flex lock nut prior to seating the nut on a bolt;

FIG. 3 (Prior Art) is a top plan view of the flex lock nut in a fully locked position;

FIG. 4 is a view in elevation of a flex lock nut 20 in the preferred embodiment of the present invention;

FIG. 5 illustrates a top plan view of the flex lock nut 20 of FIG. 4; and

FIG. 6 is a bottom view of the flex lock nut 20 of FIG. 4.

### DESCRIPTION OF THE INVENTION

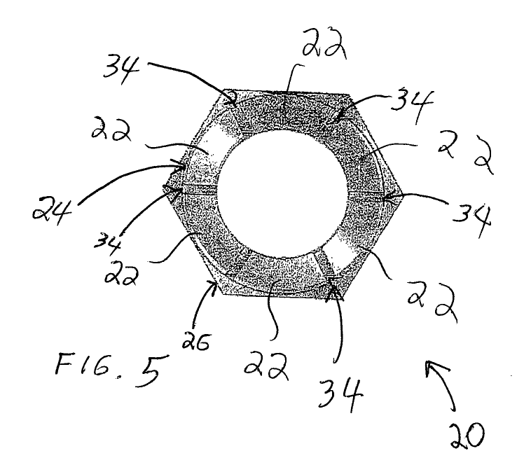

A flex lock nut having an annular recess is disclosed. FIG. 4 is a view in elevation of a flex lock nut 20 in the preferred embodiment of the present invention. The flex lock nut 20 is a one-piece reusable prevailing torque lock nut with a plurality of slotted and threaded segments 22. In the preferred embodiment of the present invention, there are six segments. However, it should be understood that any number of segments may be utilized. The flex lock nut 20 includes a collar portion 24 having a smaller diameter than a main body 26. Within the flex lock nut is a threaded bore 28. As stated above, all the segments may include threads aligned with the threaded bore 28. On a bottom end 30 from the collar portion is an annular recess 32.

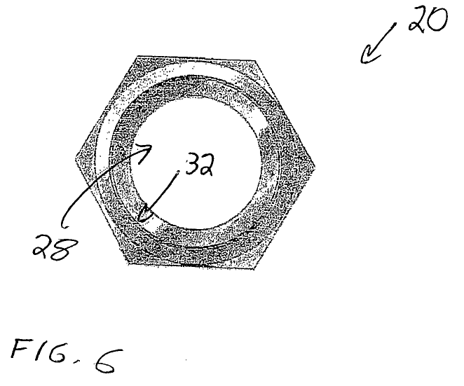

FIG. 5 illustrates a top plan view of the flex lock nut 20 of FIG. 4. Between each segment 22 is a slot 34. As is typical with flex lock nuts, the collar portion preferably includes a diameter smaller than the main body 26. The main body may include a conventional hexagonal shape.

FIG. 6 is a bottom view of the flex lock nut 20 of FIG. 4. The flex lock nut includes the annular recess 32 located on a perimeter of the threaded bore 28.

With the addition of the annular recess 28, the flex lock nut 20 provides an additional and unique locking feature not available with existing flex lock nuts. With reference to FIGS. 4-6, the operation of the flex lock nut 20 will now be explained. The nut is seated upon a bolt (not shown). As the nut is torqued down further upon a bolt, the recess is flattened downwardly, thereby deforming the entire nut. Axis B (FIG. 4) illustrates the gripping force provided by this deformation. As the recess is flattened, the axis B is pivoted inwardly toward the bore 28. Because of the placement of the annular recess 32 upon the bottom portion of the nut, this deformation is far more than is seen in a conventional locking nut.

When continuous seating is applied, at the nut bearing surfaces, there are two locking features provided. First, the flex lock nut 20 provides an inside thread locking friction at the upper end as discussed with the flex lock nut 10 in the existing art. Axis A (FIG. 4) illustrates the axis of the force exerted by this upper end locking feature. As illustrated, axis A pivots inwardly. Second, thread-locking friction is provided at an outside wall strength at the bottom end 30, which moves inwardly to provide maximum locking grip at the upper end of the nut when tightened. This locking friction is depicted as Axis B in FIG. 4. These two locking features, prevailing torque locking feature at the upper end and seated locking feature at the bottom end, produces an enhanced locking grip for use in critical applications.

In particular, as the prevailing locking feature at the upper end of the flex lock nut 20 gets lighter after multiple uses, the recess locking feature on the bottom end 30 provides a constant inward grip on the upper end to reinforce the grip on the slotted portion of the nut and increase torque life of the prevailing locking feature on the upper end. This allows the flex lock nut 20 to be reused.

In addition, when there is a torque spread in the upper end locking feature, which is common with prevailing torque lock nuts, the recess locking feature in the bearing surface on the bottom end 32 supports the upper torque area, thereby preventing the upper torque area from getting lighter when seated.

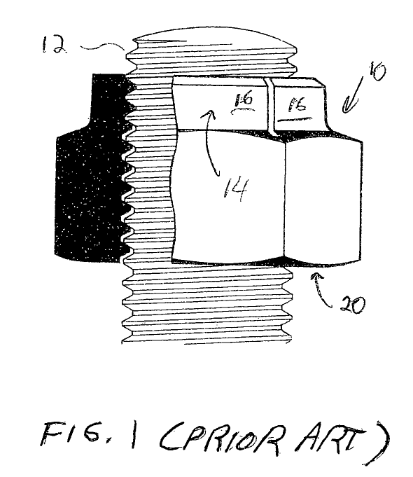

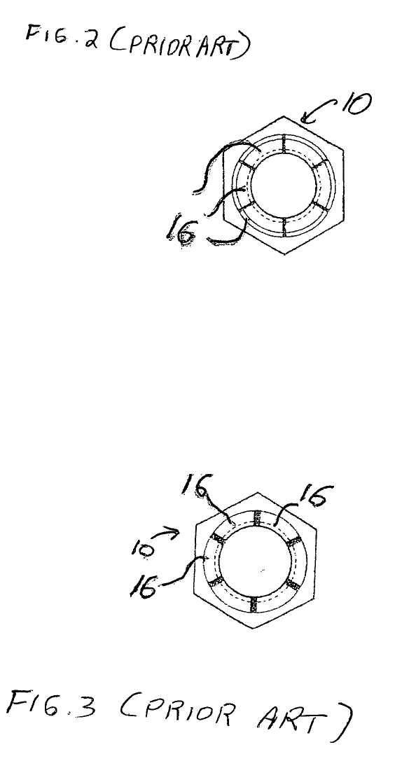

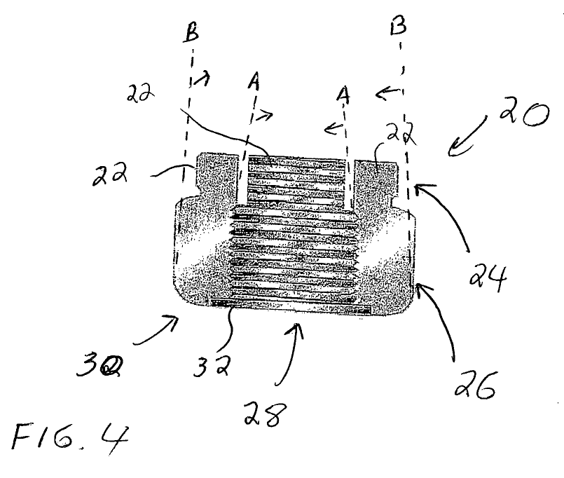

The present invention provides advantages over existing flex lock nuts. The flex lock nut 20 provides two locking features, rather than merely one locking feature. The first locking feature is the prevailing locking feature on the upper end of the nut 20 which utilizing the grip of the segments as discussed in FIGS. 1-3. The second unique and novel locking feature is the recess locking feature locked on the bottom end of the nut. The annular recess is deformed when the flex lock nut 20 is seated upon a bolt. This deformation provides a locking feature as discussed above. These two locking features provide a useful locking nut, which may be reusable.

Thus, the present invention has been described herein with reference to a particular embodiment for a particular application. Those having ordinary skill in the art and access to the present teachings will recognize additional modifications, applications and embodiments within the scope thereof.

It is therefore intended by the appended claims to cover any and all such applications, modifications and embodiments within the scope of the present invention.

What is claimed is:

1. A lock nut, said lock nut comprising:
a nut body having a bore with an interior threaded portion, said nut body having an upper end and a bottom end;
a plurality of slotted segments extending from a collar portion located on the upper end of said nut body, said slotted segments being substantially coaxial with the bore;
an annular recess positioned upon the bottom end of said nut body, said annular recess being coaxial with the threaded portion of the bore;
said plurality of slotted segments expanding when said nut body is seated upon a threaded bolt to provide an upper locking friction to prevent rotation of said nut body; and
said annular recess providing a lower locking force to prevent rotation of said nut body when said nut body is seated upon the threaded bolt.

2. The lock nut of claim 1 wherein an interior wall of each segment is threaded and aligned with the interior threaded portion of said nut body.

3. The lock nut of claim 1 wherein said nut body is hexagonal in shape.

4. The lock nut of claim 1 wherein the collar portion has a diameter smaller than said nut body.

5. The lock nut of claim 1 wherein six slotted segments extend from the collar portion.

6. The lock nut of claim 1 wherein:
said nut body is hexagonal in shape to form six planar exterior surfaces; and
six slotted segments extend from the collar portion, each segment aligned with one of the planar exterior surfaces.

7. A lock nut, said lock nut comprising:
a nut body having a bore with an interior threaded portion, said nut body having an upper end and a bottom end, said nut body being hexagonal in shape and having six planar exterior surfaces;
a collar portion located on the upper end of said nut body, said collar portion having a diameter smaller than said nut body;
a plurality of six slotted segments extending from said collar portion, each segment being aligned with one of the planar exterior surfaces;
said plurality of slotted segments forming a threaded interior and being coaxially aligned with the bore;
an annular recess positioned upon the bottom end of said nut body, said annular recess being circumferentially positioned on an outer perimeter of the bore at the bottom end of said nut body;
said plurality of slotted segments expanding when said nut body is positioned upon a threaded bolt to provide an upper locking friction to prevent rotation of said nut body; and
said annular recess deforming when said nut body is seated upon the threaded bolt to provide a lower locking friction to prevent rotation of said nut body.

8. A lock nut, said lock nut comprising:
a six-sided nut body having a threaded bore running from an upper portion to a lower portion of said nut body;
six slotted segments extending from the upper portion of said nut body and forming a collar portion, the collar portion having a smaller diameter than said nut body;
an annular recess positioned on a perimeter about the bore at the lower portion of said nut body;
whereby said slotted segments expand to provide an upper locking frictional force upon a bolt being threaded within the bore and said annular recess deforms to provide a lower locking force upon the bolt as the nut body is seated upon the bolt, thereby preventing inadvertent rotation of said lock nut.
